(19) United States
(12) Patent Application Publication
(10) Pub. No.: US 2015/0379754 A1
(43) Pub. Date: Dec. 31, 2015

(54) IMAGE PROCESSING APPARATUS, ANIMATION CREATION METHOD, AND COMPUTER-READABLE MEDIUM

(71) Applicant: CASIO COMPUTER CO., LTD., Tokyo (JP)

(72) Inventor: Shoichi OKANIWA, Tokyo (JP)

(73) Assignee: CASIO COMPUTER CO., LTD., Tokyo (JP)

(21) Appl. No.: 14/666,290

(22) Filed: Mar. 23, 2015

(30) Foreign Application Priority Data
Jun. 25, 2014 (JP) 2014-130220

(51) Int. Cl. G06T 13/40

(52) U.S. Cl. CPC G06T 13/40

(57) ABSTRACT

According to an image processing apparatus, a control unit creates an animation that sets initial positions of parts of an image, such as the head, lips, and eyelids, and moves the parts of the image with positions of the parts of the image in the first frame as their set initial positions, and moves the parts of the image in such a manner as that positions of the parts of the image in the last frame coincide with the set initial positions.

### BACKGROUND

1. Technical Field

The present invention relates to an image processing apparatus, an animation creation method, and a computer-readable medium.

2. Related Art

An animation creation apparatus is conventionally known which deforms a face model and creates animation (for example, refer to JP 2003-132365 A).

If an animation is created from one face image, the movements of the mouth are added to the face image in synchronization with the voice. In this case, it looks unnatural if only the mouth is moved. Accordingly, random movements such as the swing of the head and blinks are added to express more natural gestures.

However, if the head is swung and the eyes are blinked randomly, the position and orientation of the head, the degrees of opening of the eyes, and the like do not agree between the start and the end of the animation in most cases. Hence, for example, if one long animation is created by dividing the animation into a plurality of sections, creating animations, and combining them later, there is a problem that continuity cannot be provided to the position and orientation of the head, the degrees of opening of the eyes, and the like at the combined points so that the animation becomes unnatural with awkwardness.

An issue of the present invention is to make it possible to provide an animation without awkwardness where continuity is held even if a plurality of animations is created from one image and combined.

### SUMMARY

An image processing apparatus comprising:

a control unit configured to:

set a first position of a first area being part of an image;

move the first area; and

return the first area to the first position after moving the first area for a first time period.

The present invention can provide an animation without awkwardness where continuity is held even if a plurality of animations is created from one image and combined.

### BRIEF DESCRIPTION OF THE DRAWINGS

FIG. 1 is a diagram illustrating an example of the entire configuration of an animation processing system in the embodiment;

FIG. 2 is a block diagram illustrating a functional configuration of an image processing apparatus of FIG. 1;

FIG. 3 is a block diagram illustrating a functional configuration of a digital signage apparatus of FIG. 1;

FIG. 4 is a diagram illustrating a schematic configuration of a screen unit of FIG. 3;

FIG. 5 is a flowchart illustrating an animation creation process to be executed by a control unit of FIG. 2;

FIG. 6 is a flowchart illustrating a head swing process to be executed in step S2 of FIG. 5;

FIG. 7A is a diagram illustrating a parameter of the rotation angle;

FIG. 7B is a diagram illustrating a parameter of the rotation angle;

FIG. 7C is a diagram illustrating a parameter of the rotation angle;

FIG. 8 is a flowchart illustrating a lip-syncing process to be executed in step S3 of FIG. 5; and

FIG. 9 is a flowchart illustrating a blinking process to be executed in step S4 of FIG. 5.

### DETAILED DESCRIPTION

Hereinafter, a preferred embodiment of the present invention is described in detail with reference to the accompanying drawings. The present invention is not limited to illustrated examples.

### [The Configuration of the Animation Processing System 100]

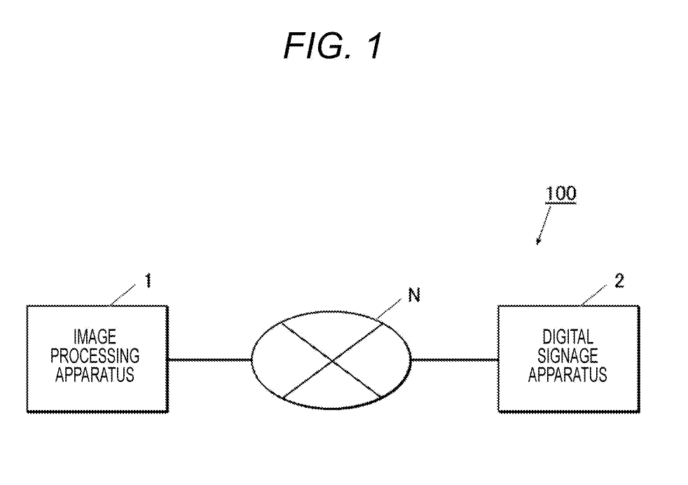

FIG. 1 is a diagram illustrating the entire configuration of an animation processing system 100 in the embodiment of the present invention. The animation processing system 100 is configured by connecting an image processing apparatus 1 to a digital signage apparatus 2 via a communication network N such as a LAN (Local Area Network), a WAN (Wide Area Network), or the Internet in such a manner as to be able to transmit and receive data.

### [The Configuration of the Image Processing Apparatus 1]

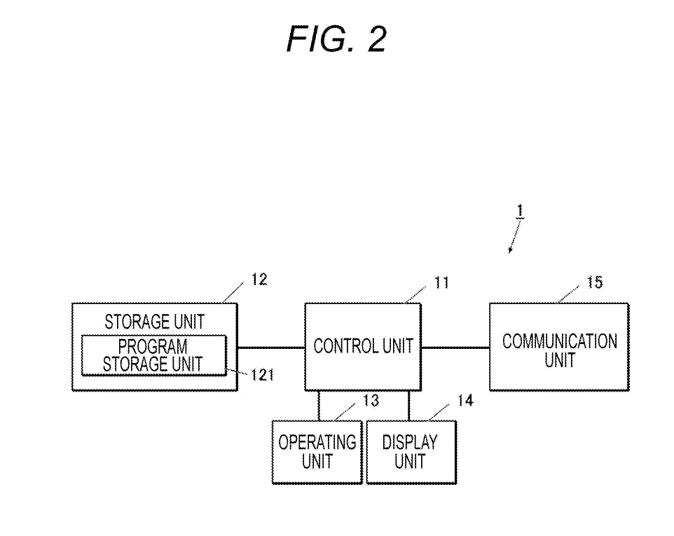

FIG. 2 is a block diagram illustrating a main control configuration of the image processing apparatus 1. The image processing apparatus 1 is an apparatus that creates an animation (moving image data) based on one face image, and transmits the created moving image data to the digital signage apparatus 2. For example, a PC (Personal Computer) and the like are applicable. As illustrated in FIG. 2, the image processing apparatus 1 is configured including a control unit 11, a storage unit 12, an operating unit 13, a display unit 14, and a communication unit 15.

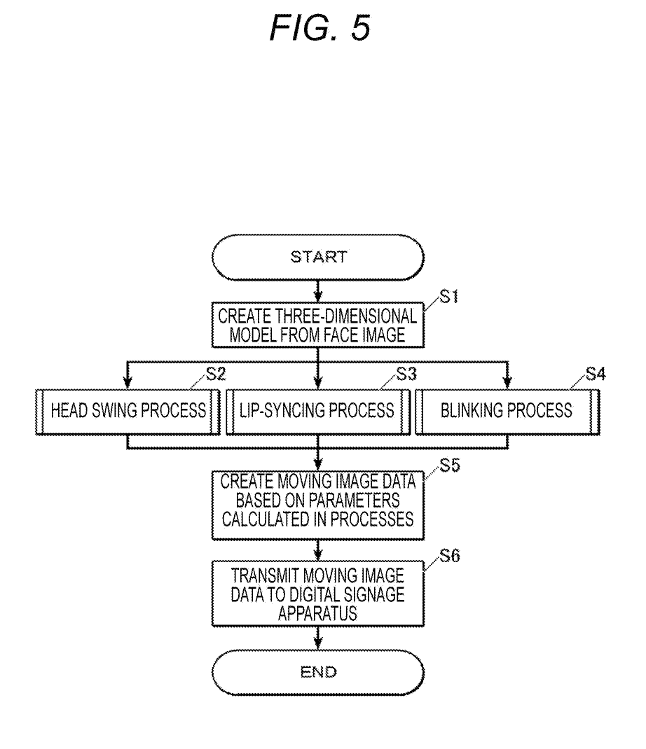

The control unit 11 includes a CPU (Central Processing Unit) that executes various programs stored in a program storage unit 121 of the storage unit 12 to perform predetermined operations and control each unit, and a memory to serve as a work area upon the execution of a program (the illustration of any of which is omitted). The control unit 11 executes an animation creation process illustrated in FIG. 5 in cooperation with a program stored in the program storage unit 121 of the storage unit 25, and transmits the created moving image data to the digital signage apparatus 2. The control unit 11 functions as a first setting unit, a second setting unit, a third setting unit, a first animation unit, a first animation control unit, a second animation unit, a second animation control unit, a third animation unit, and a third animation control unit.

The storage unit 12 includes an HDD (Hard Disk Drive) and a nonvolatile semiconductor memory. The storage unit 12 is provided with the program storage unit 121 as illustrated in FIG. 2. A system program to be executed by the control unit 11, process programs for executing various processes including the animation creation process described below, data necessary to execute these programs, and the like are stored in the program storage unit 121.

Moreover, a face image (a still image. A two-dimensional image in the embodiment) to be based for the creation of an animation, and voice data for the animation are stored in the storage unit 12. The voice data may be text data expressing voice.

The operating unit 13 is configured including a keyboard with a cursor key, a character input key, a numeric keypad, various function keys, and the like, and a pointing device such as a mouse. The operating unit 13 outputs, to the control unit 11, instruction signals input by a key operation on the keyboard and a mouse operation. Moreover, the operating unit 13 may include a touch panel on a display screen of the display unit 14. In this case, the operating unit 13 outputs, to the control unit 11, an instruction signal input via the touch panel.

The display unit 14 is configured of, for example, an LCD (Liquid Crystal Display) or CRT (Cathode Ray Tube) monitor, and displays various screens in accordance with instructions of display signals input from the control unit 11.

The communication unit 15 is configured of a modem, a router, a network card, and the like, and communicates with an external device connected to the communication network N.

### [The Configuration of the Digital Signage Apparatus 2]

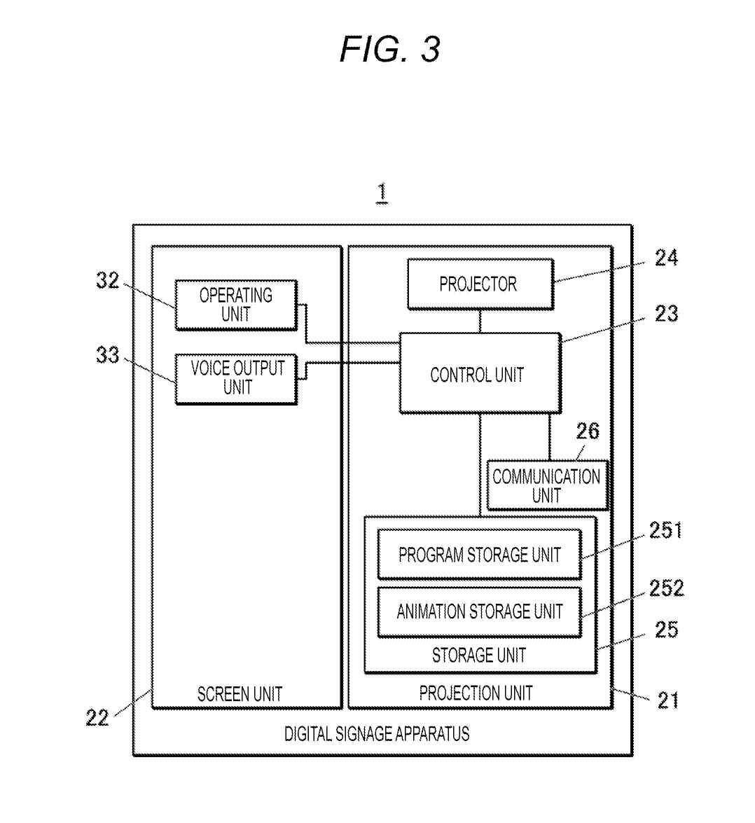

FIG. 3 is a block diagram illustrating a main control configuration of the digital signage apparatus 2. The digital signage apparatus 2 is an apparatus that displays an animation based on the moving image data created in the image processing apparatus 1.

As illustrated in FIG. 3, the digital signage apparatus 2 includes a projection unit 21 that applies video light, and a screen unit 22 that receives the video light applied by the projection unit 21 at the rear and projects the video light to the front.

Firstly, the projection unit 21 is described.

The projection unit 21 includes a control unit 23, a projector 24, a storage unit 25, and a communication unit 26. The projector 24, the storage unit 25, and the communication unit 26 are connected to the control unit 23 as illustrated in FIG. 3.

The control unit 23 includes a CPU that executes various programs stored in a program storage unit 251 of the storage unit 25 to perform predetermined operations and control each unit, and a memory to serve as a work area upon the execution of a program (the illustration of any of which is omitted).

The projector 24 is a projection apparatus that converts image data output from the control unit 23 into video light, and applies the video light toward the screen unit 22. It is possible to apply, to the projector 24, for example, a DLP (Digital Light Processing) (registered trademark) projector using a DMD (Digital Micromirror Device) being a display device that performs a display operation by operating the inclination angle of each of a plurality of (in a case of XGA, 1024 horizontal pixels x 768 vertical pixels) micromirrors arranged in an array to an on or off state at high speeds and accordingly forms an optical image by their reflected lights.

The storage unit 25 includes an HDD (Hard Disk Drive) and a nonvolatile semiconductor memory. The storage unit 25 is provided with the program storage unit 251 as illustrated in FIG. 3. A system program to be executed by the control unit 23, various process programs, data necessary to execute these programs, and the like are stored in the program storage unit 251.

Moreover, the storage unit 25 is provided with an animation storage unit 252 where the moving image data of the animation transmitted from the image processing apparatus 1 is stored. The moving image data is configured of a plurality of frame images, and voice data corresponding to each frame image.

Next, the screen unit 22 is described.

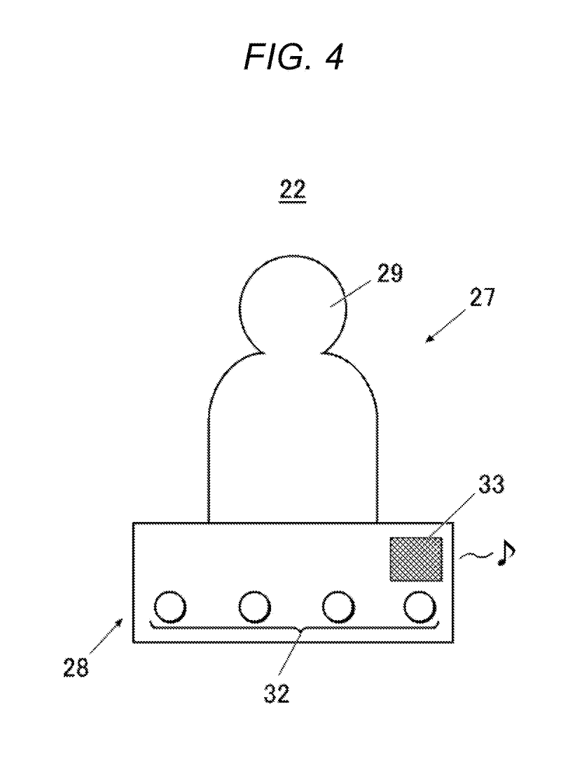

FIG. 4 is a front view illustrating a schematic configuration of the screen unit 22. As illustrated in FIG. 4, the screen unit 22 includes an image formation unit 27, and a base 28 that supports the image formation unit 27.

The image formation unit 27 is a screen configured by affixing a film screen for rear projection onto which a film-shaped Fresnel lens is laminated to one transparent plate 29, such as an acrylic plate, formed into a human shape and arranged substantially orthogonal to the video light application direction. The image formation unit 27 and the above-mentioned projector 24 form a display unit.

The base 28 is provided with a button-type operating unit 32, and a voice output unit 33, such as a speaker, that outputs voices.

The operating unit 32 includes various operating buttons, detects a press signal of an operating button, and outputs the press signal to the control unit 23.

The operating unit 32 and the voice output unit 33 are connected to the control unit 23 as illustrated in FIG. 3.

### [The Operation of the Animation Processing System 100]

Next, the operation of the animation processing system 100 is described.

As described above, in the animation processing system 100, the image processing apparatus 1 creates moving image data of an animation based on one face image and voice data, and the digital signage apparatus 2 displays the animation based on the created moving image data.

There are various factors to create a more natural animation of a face. However, in the embodiment, an animation is created which moves not only the mouse in synchronization with the voice but further moves the head and eyes.

FIG. 5 illustrates a flowchart of the animation creation process to be executed in the image processing apparatus 1. The animation creation process is executed in cooperation with the control unit 11 and the program stored in the program storage unit 121 when the operating unit 13 designates a face image and voice data, which are targeted for animation, from face images and voice data stored in the storage unit 12 to instruct the creation of an animation.

Firstly, the control unit 11 reads the face image designated by the operating unit 13 from the storage unit 12, and creates a three-dimensional model based on the read face image (hereinafter referred to as the face model) (step S1). Any known method may be used for the creation of a three-dimensional model.

Next, the control unit 11 executes a head swing process (step S2), a lip-syncing process (step S3), and a blinking process (step S4) based on the created three-dimensional model.

Hereinafter, the head swing process, the lip-syncing process, and the blinking process are described. The head swing process, the lip-syncing process, and the blinking process are image processing to move the head, mouth, and eyes (processes for calculating parameters for each frame in such a manner as to move the head, mouth, and eyes), respectively. The head swing process, the lip-syncing process, and the blinking process may be performed sequentially, or two or three of them may be performed in parallel.

### (The Head Swing Process)

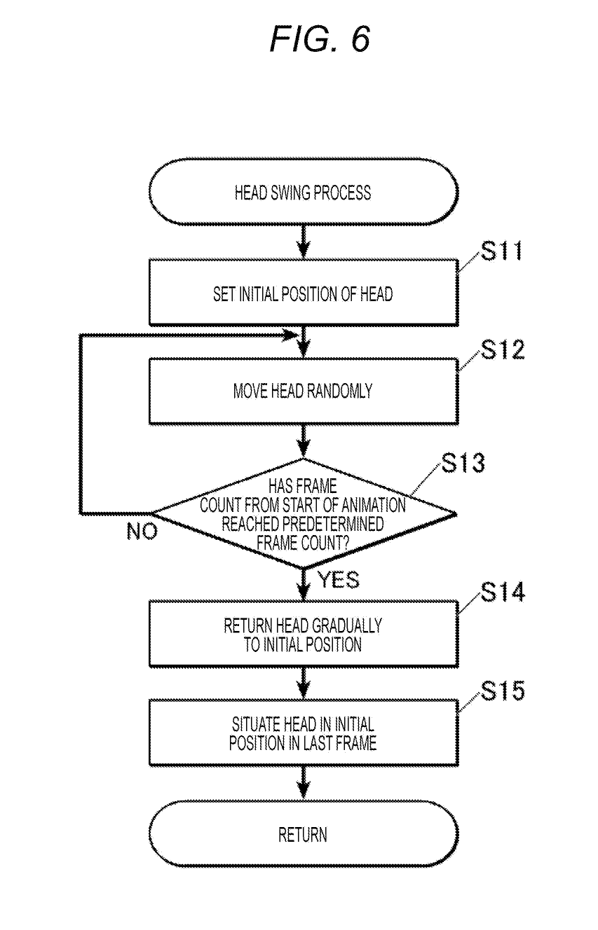

FIG. 6 illustrates a flowchart of the head swing process executed in the image processing apparatus 1 in step S2 of FIG. 5. The head swing process is executed in cooperation with the control unit 11 and a program stored in the program storage unit 121.

Firstly, the control unit 11 sets an initial position (first position) of the head (first area) (step S11).

For example, the position of the head can be represented by parameters (X0, Y0, Z0) indicating the position of a reference point O (for example, the center of gravity of the head) with respect to the head and parameters (a, b, c) indicating the direction in which the face (head) is facing. Hereinafter, let the frame count (a frame number. The first frame number=0) from the start of animation be t. The values of the parameters X0, Y0, and Z0 at t are respectively expressed as X0(t), Y0(t), and Z0(t), and the values of the parameters a, b, and c at t are respectively expressed as a(t), b(t), and c(t).

For example, in step S11, firstly, the control unit 11 sets an appropriate position (fixed position) of the face model as an origin, and sets a coordinate space with the up and down direction as the Y-axis direction, the back and forth direction as the Z-axis direction, and a direction orthogonal to the Y- and Z-axis directions (the left and right direction) as the X-direction.

Next, the control unit 11 acquires the coordinates of the position of the reference point O of the head of the face model created in step S1 in the coordinate space, and stores the acquired coordinates in the memory, setting the coordinates as parameters X0(0), Y0(0), Z0(0) indicating the position (initial position) of the head in the first frame.

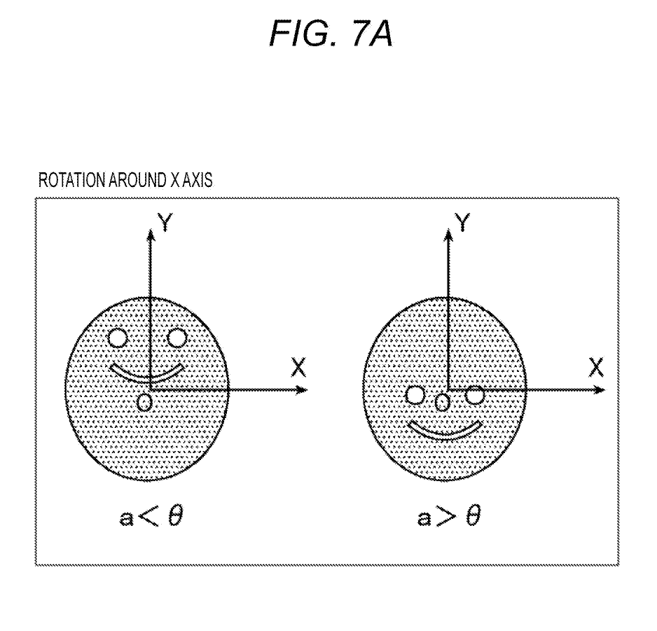

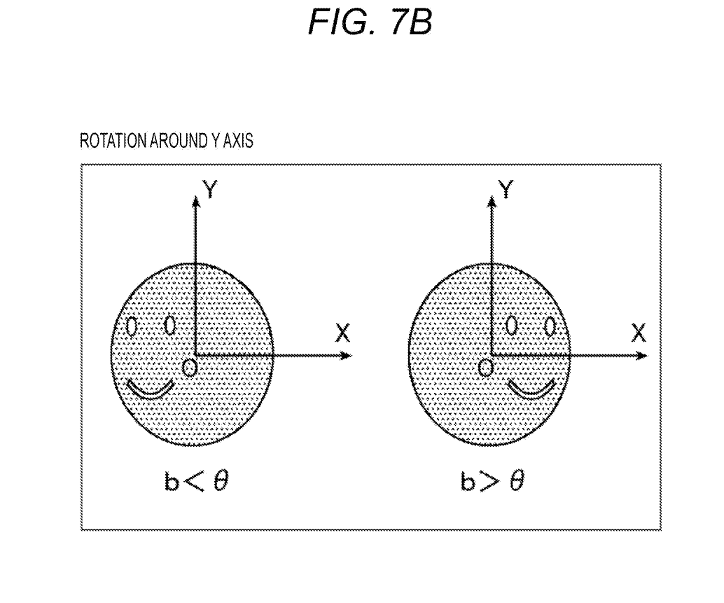

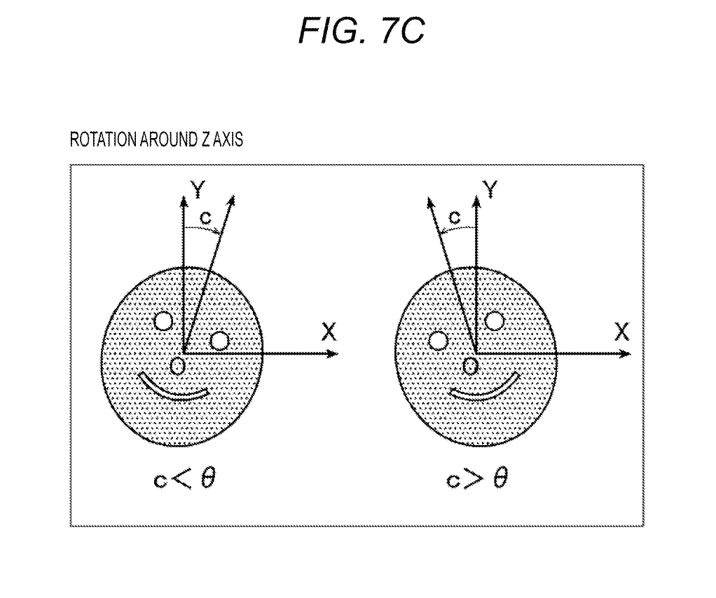

Next, the control unit 11 sets the parameters a, b, and c indicating the direction in which the face is facing. a is the rotation angle where the X axis of the XYZ coordinate space (the direction of each axis is as described above) with the reference point O as the origin is set as the axis of rotation, and is the rotation angle of the head when the person of the face model nods as illustrated in FIG. 7A. b is the rotation angle where the Y axis of the XYZ coordinate space with the reference point O as the origin is set as the axis of rotation, and is the rotation direction of the head when the person of the face model shakes his/her head as illustrated in FIG. 7B. c is the rotation angle where the Z axis of the XYZ coordinate space with the reference point O as the origin is set as the axis of rotation, and is the rotation direction of the head when the person of the face model tilts his/her head as illustrated in FIG. 7C. The control unit 11 sets the rotation angles a, b, and c of the face model created in step S1 as 0°, respectively, sets the parameters a(0)=0, b(0)=0, and c(0)=0 indicating the direction (initial direction) in which the face is facing in the first frame, and stores the parameters in the memory.

Next, the control unit 11 performs the process of moving the head randomly (step S12). Specifically, the parameters of each frame are calculated in order of frame numbers in such a manner as to move the head randomly, associated with the frame number, and stored in the memory. For example, the parameters X0, Y0, Z0, a, b, and c are increased/decreased randomly, frame by frame. Accordingly, the position of the head and the orientation of the face can be moved randomly. At this point in time, it is preferred to restrict the parameters a, b, and c to a range of −10°<a, b, c<10° in order to avoid unnatural gestures. Moreover, it is also preferred to restrict the range that can be taken by the parameters X0, Y0, and Z0.

Next, the control unit 11 judges whether or not t has reached a predetermined frame count s (step S13). In other words, it is judged whether or not the head has been moved for a predetermined time period corresponding to the predetermined frame count s. If having judged that t did not reach the predetermined frame count s (step S13; NO), the control unit 11 returns to step S12.

If having judged that t reached the predetermined frame count s (step S13; YES), the control unit 11 performs the process of returning the head gradually to the initial position (step S14). Specifically, the parameters of each frame after the frame number s are calculated in such a manner as to return the head gradually to the initial position, associated with the frame number, and stored in the memory. For example, the parameters are calculated for each frame after the frame number s based on the following equations. Accordingly, the head is gradually brought close to the initial position. Here, px, py, pz, pa, pb, and pc are constants. 0<px, py, pz, pa, pb, pc<1. The values of the constants are determined based on the number of frames up to the last frame, the current parameter values, and the like.

X0(t)=px(X0(0)−X0(t−1))+X0(t−1)

Y0(t)=py(Y0(0)−Y0(t−1))+Y0(t−1)

Z0(t)=pz(Z0(0)−Z0(t−1))+Z0(t−1)

a(t)=pa(a(0)−a(t−1))+a(t−1)

b(t)=pb(b(0)−b(t−1))+b(t−1)

c(t)=pc(c(0)−c(t−1))+c(t−1)

When having reached the last frame, the control unit 11 situates the head at the initial position (step S6). Specifically, the parameters X0, Y0, Z0, a, b, and c of the last frame are respectively set to the same values as X0(0), Y0(0), Z0(0), a(0), b(0), and c(0) stored in the memory, associated with the frame number, and stored in the memory. The control unit 11 then ends the head swing process.

### (The Lip-Syncing Process)

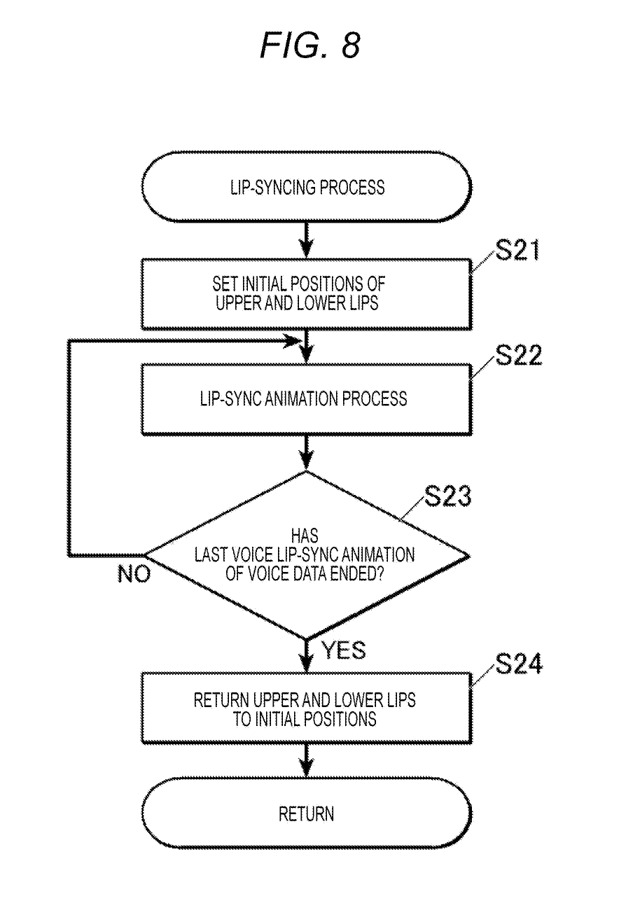

FIG. 8 illustrates a flowchart of the lip-syncing process to be executed in the image processing apparatus 1 in step S3 of FIG. 5. The lip-syncing process is executed in cooperation with the control unit 11 and a program stored in the program storage unit 121.

In the embodiment, the mount of the face image (face model) is assumed to be closed.

Firstly, the control unit 11 sets initial positions (a third position) of the upper and lower lips (a third area) based on the operation of the operating unit 13 or the like by a user (step S21).

Parameters representing the positions of the upper and lower lips can be expressed as, for example, coordinates Xi, Yi, Zi (i=1 to n (n is the number of feature points (a positive integer)) of a plurality of feature points of the upper and lower lips. For example, when a boundary between the upper and lower lips in the face model created in step S1 is designated by the mouse or the like of the operating unit 13, the control unit 11 acquires the coordinates of the positions of points of distinctive parts on the designated boundary (feature points. For example, ends and mid-point of each of the upper and lower lips), and stores the acquired coordinates, as parameters Xi(0), Yi(0), and Zi(0) indicating the positions (initial positions) of the upper and lower lips in the first frame, in the memory.

The values of the parameters Xi, Yi, and Zi at the frame count t from the start of animation are respectively expressed as Xi(t), Yi(t), and Zi(t).

The above-mentioned parameters Xi, Yi, and Zi representing the positions of the upper and lower lips can define the shape of the mouth.

Next, the control unit 11 reads voice data designated by the operating unit 13, and performs a lip-sync animation process on the face model (step S22).

Here, let the frame rate of moving image data to be created be P (frames/second), and let the playback time period of the voice data be T (seconds). In step S13, the voice data is acquired, piece by piece, for each time period corresponding to one frame (1/P (second/frame)), from the start of the voice data. An analysis is made, frame by frame, of the voice data corresponding to the frame. The parameters Xi, Yi, and Zi (i=1 to n) are changed so as to form the mouth into a shape in accordance with the vowel uttered in the frame, associated with the frame number, and stored in the memory.

The control unit 11 determines whether or not the last voice lip-sync animation process on the voice data has ended (step S23). If having determined that the last voice lip-sync animation process on the voice data did not end, the control unit 11 returns to step S22 and continues the lip-sync animation process. If having determined in step S23 that the last voice lip-sync animation on the voice data ended, the control unit 11 performs the animation process of returning the upper and lower lips to the initial positions (step S24).

Specifically, the values of the parameters Xi, Yi, and Zi (i=1 to n) of the last frame are respectively set to the same values as Xi(0), Yi(0), and Zi(0) stored in the memory, associated with the frame number, and stored in the memory. The lip-syncing process is then ended.

### (The Blinking Process)

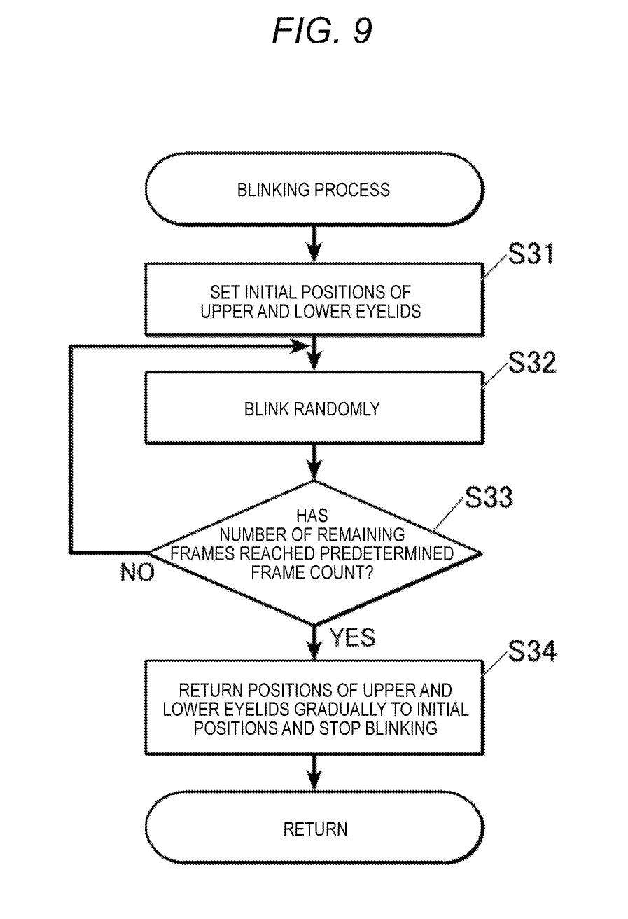

FIG. 9 illustrates a flowchart of the blinking process to be executed in the image processing apparatus 1 in step S4 of FIG. 5. The blinking process is executed in cooperation with the control unit 11 and a program stored in the program storage unit 121.

In the embodiment, the eyes of the face image (face model) are assumed to be open.

Firstly, the control unit 11 sets the initial positions (second position) of the upper and lower eyelids (second area) based on the operation of the operating unit 13 or the like by the user (step S31).

Parameters representing the positions of the upper and lower eyelids can be expressed as, for example, coordinates Xej, Yej, Zej (j=1 to m (m is the number of feature points (a positive integer)) of a plurality of feature points of the contours of the eye (both of the upper and lower eyelid sides). For example, when the upper and lower eyelid sides of the contours of the eye in the face model created in step S1 are designated by the mouse or the like of the operating unit 13, the control unit 11 acquires the coordinates of the positions of points of distinctive parts on the designated contours (feature points. For example, ends and mid-point of each of the upper and lower eyelid sides), and stores the acquired coordinates, as parameters Xej(0), Yej(0), and Zej(0) indicating the positions (initial positions) of the upper and lower eyelids in the first frame, in the memory.

The values of the parameters Xej, Yej, and Zej at the frame count t from the start of animation are respectively expressed as Xej(t), Yej(t), and Zej(t).

The above-mentioned parameters Xej, Yej, and Zej representing the positions of the upper and lower eyelids can define the shape of the eye such as the degree of the opening of the eye.

Next, the control unit 11 causes the face model to blink the eyes randomly (step S32). Specifically, the parameters Xej, Yej, and Zej are calculated for each frame in such a manner as to cause the eyes of the face model to blink randomly, associated with a frame number, and stored in the memory. Specifically, the parameters Xej, Yej, and Zej are changed, frame by frame, to repeatedly open and close the contours of the upper and lower eyelid sides. Accordingly, blinks are performed.

If blinks are performed continuously in a short time, it looks unnatural. Therefore, after a blink is performed, the next blink is not performed for a certain time period (for example, after a blink, the parameters are not changed for frames corresponding to the certain time period).

Next, the control unit 11 judges whether or not the number of remaining frames of the moving image data (content) created based on the face image has reached a predetermined frame count s1 (step S33). Here, the predetermined frame count s1 is, for example, the number of frames corresponding to a time period during which it does not look unnatural even if the person does not blink. If having judged that the number of remaining frames did not reach the predetermined frame count s1 (step S33; NO), the control unit 11 returns to step S32.

If having judged that the number of remaining frames reached the predetermined frame count s1 (step S33; YES), the control unit 11 performs the process of returning the positions of the upper and lower eyelids gradually to the initial positions, and attempts not to perform the blinking process (step S34).

Consequently, if the remaining time of the content is determined to be a time period during which it does not look unnatural without blinks, the upper and lower eyelids are returned to their initial positions to stop blinking. Accordingly, the first frame can coincide with the last frame.

The head swing process, the lip-syncing process, and the blinking process include the process of moving the head, mouth (upper and lower lips), and eyes (upper and lower eyelids), which are respectively parts of the face image, (the first animation unit, the third animation unit, and the second animation unit), and the process of moving them so as to return them to their set initial positions after their movements (the first animation control unit, the second animation control unit, and the third animation control unit). Therefore, moving image data can be created in such a manner as that the positions of conspicuous parts, such as the head, mouth, and eyes, in the face image coincide between the first and last frames of the animation.

When having finished the head swing process, the lip-syncing process, and the blinking process, the control unit 11 creates the moving image data of animation based on the parameters calculated in the processes (step S5). Specifically, the parameters calculated in the processes, associated with each frame number, and stored in the memory are read out, and image data of each frame is created based on the read parameters. The created image data of each frame is combined. Voice data is combined with the image data to create moving image data.

When the creation of the moving image data ends, the control unit 11 transmits the created moving image data to the digital signage apparatus 2 with the communication unit 15 (step S6), and ends the animation creation process.

In the digital signage apparatus 2, when having received the moving image data from the image processing apparatus 1 with the communication unit 26, the control unit 23 stores the received moving image data in the animation storage unit 252 of the storage unit 25. When the playback time of the animation has come, the control unit 23 reads the moving image data from the animation storage unit 252, transmits the image data to the projector 24, and displays images of the animation on the image formation unit 27. Moreover, the voice data of the moving image data is output to the voice output unit 33, and the voice of the animation is output.

As described above, according to the image processing apparatus 1, the control unit 11 creates an animation in such a manner as to set initial positions of parts of an image, such as the head, mouth (lips), and eyes (eyelids), move the parts of the image, and then move them to return them to their set initial positions. Specifically, an animation is created which moves parts of the image with positions of the parts of the image in the first frame as the set initial positions and moves the parts of the image in such a manner as that positions of the parts of the image in the last frame coincide with the set initial positions.

Therefore, for example, the moved parts of the image coincide between the start and the end of the animation. Accordingly, even if a plurality of animations is created from one image and combined, it becomes possible to provide an animation without awkwardness where continuity is held.

For example, the parts of the image, such as the head and eyelids, are moved randomly from the set initial positions. Accordingly, it is possible to create an animation that expresses natural motion.

Moreover, the parts of the image are returned gradually to the set initial positions. Accordingly, it is possible to return them to the initial positions without awkwardness.

The described contents of the embodiment are a preferred example of the image processing apparatus according to the present invention. The image processing apparatus according to the present invention is not limited to the embodiment.

For example, in the embodiment above, an example has been described where the face image is a two-dimensional image. However, the face image may be an image of a three-dimensional model. In this case, the process of step S1 of FIG. 5 is omitted.

Moreover, in the embodiment above, an example has been described where the positions of the head and eyelids are gradually returned to their initial positions in an animation. However, in the present invention, the head and eyelids are simply required to be situated in the same positions in the first and last frames. How to return them to the initial positions are not limited to the above case. For example, the position of the head and the positions of the upper and lower eyelids may be returned gradually to the initial positions while being moved randomly. Consequently, it becomes possible to return the head and eyes to the initial positions without awkwardness, adding natural movements to the head and eyes.

Moreover, in the embodiment, the parameters of the head, mouth, and eyes are required to agree between the first and last frames. However, all parameters including other parameters are caused to agree between the first and last frames. Accordingly, if an animation is created by being divided into a plurality of sections, and combining them into one animation in the end, sectional animations can be continuously connected more naturally.

Moreover, in the embodiment above, an example has been described where the image processing apparatus 1 performs the animation creation process, the image processing apparatus 1 being a separate body from the digital signage apparatus 2 which displays an animation. However, the digital signage apparatus 2 may perform the animation creation process in cooperation with the control unit 23 and a program.

Moreover, in the embodiment above, an example has been described where the image formation unit 27 of the digital signage apparatus 2 has a human shape. However, the image formation unit 27 may have another shape, and is not limited to the human shape.

In addition, the detailed configurations and operations of the image processing apparatus and the digital signage apparatus can also be changed within a scope that does not depart from the spirit of the invention, as appropriate.

Some embodiments of the present invention have been described. However, the scope of the present invention is not limited to the above-mentioned embodiments, and includes the scope of the invention described in the claims, and equivalents thereof.

What is claimed is:

1. An image processing apparatus comprising:
a control unit configured to:
set a first position of a first area being part of an image;
move the first area; and
return the first area to the first position after moving the first area for a first time period.

2. The image processing apparatus according to claim 1, wherein the control unit
sets a second position of a second area in the first area,
moves the second area, and
stops the animation of the second area and returns the second area to the second position upon the remaining time of a content based on the image being a second time period.

3. The image processing apparatus according to claim 1, wherein the control unit
sets a third position of a third area in the first area,
moves the third area, and
returns the third area to the third position upon a predetermined condition being satisfied.

4. The image processing apparatus according to claim 1, wherein the control unit
sets a position of the first area in a first frame as the set first position to move the first area, and
moves a position of the first area in a last frame to the set first position.

5. The image processing apparatus according to claim 1, wherein the control unit moves the first area randomly from the set first position.

6. The image processing apparatus according to claim 1, wherein the control unit returns the first area gradually to the set first position.

7. The image processing apparatus according to claim 1, wherein the control unit returns the first area gradually to the set position, moving the first area randomly.

8. The image processing apparatus according to claim 1, wherein the control unit moves the first area by changing a parameter defining the position of the first area on a frame-by-frame basis.

9. The image processing apparatus according to claim 2, wherein the second time period is a time period during which it does not look unnatural even when the control unit does not move the second area.

10. The image processing apparatus according to claim 3, wherein
an animation that moves the third area is a lip-sync animation, and
the predetermined condition is whether or not the last voice lip-sync animation has ended.

11. The image processing apparatus according to claim 1, wherein the first area is the head of a face image.

12. The image processing apparatus according to claim 2, wherein the second area is the upper and lower eyelids of a face image.

13. An image processing method comprising the steps of:
setting a first position of a first area being part of an image;
moving the first area;
returning the first area to the first position after moving the first area for a first time period in the step of moving the first area.

14. A computer-readable medium for causing a computer to execute:
setting a first position of a first area being part of an image;
moving the first area;
returning the first area to the first position after moving the first area for a first time period by the process of moving the first area.
